(19) United States
(12) Patent Application Publication
(10) Pub. No.: US 2023/0273625 A1
(43) Pub. Date: Aug. 31, 2023

(54) METHOD AND SYSTEM FOR CONTROLLING SAFE TAKEOFF AND LANDING OF PILOTLESS VERTICAL TAKEOFF AND LANDING (VTOL) AIRCRAFT

(71) Applicant: Tao Ma, San Jose, CA (US)

(72) Inventor: Tao Ma, San Jose, CA (US)

(21) Appl. No.: 18/144,246

(22) Filed: May 8, 2023

Related U.S. Application Data
(63) Continuation of application No. 16/445,184, filed on Jun. 18, 2019, now abandoned.

(51) Int. Cl. G05D 1/10; B64C 29/00; B64C 39/02; B64D 47/08; G05D 1/00; B64F 3/00

(52) U.S. Cl. CPC G05D 1/102; B64C 29/0025; B64C 39/02; B64D 47/08; G05D 1/0088; B64F 3/00

(57) ABSTRACT

In one aspect, a system for performing a pre-takeoff passenger safety procedure for a pilotless vertical takeoff and landing (VTOL) aircraft is disclosed. The system can begin by receiving authentication information from each of one or more passengers attempting to enter a passenger cabin of the VTOL. The system then authenticates each of the one or more passengers as an authorized passenger based on the authentication information. If the one or more passengers are successfully authenticated, the system allows the one or more passengers to enter the passenger cabin of the VTOL aircraft, and subsequently performs a set of onboard pre-takeoff checks to determine if the VTOL aircraft and the one or more passengers are safe for takeoff. In response to determining that the VTOL aircraft and the one or more passengers are safe for takeoff, the system further confirms readiness of each of the passengers for immediate takeoff.

### PRIORITY CLAIM AND RELATED PATENT APPLICATIONS

This patent application is a continuation of, and hereby claims the benefit of priority under 35 U.S.C. § 120 to co-pending U.S. patent application Ser. No. 16/445,184, filed on Jun. 18, 2019 (Attorney Docket No. MT001.US02CON), entitled, “METHOD AND SYSTEM FOR CONTROLLING SAFE TAKEOFF AND LANDING OF PILOTLESS VERTICAL TAKEOFF AND LANDING (VTOL) AIRCRAFT,” by inventor Tao Ma, which itself is a continuation of, and claims priority to, U.S. patent application Ser. No. 15/256,755, entitled “METHOD AND SYSTEM FOR TRANSPORTING PASSENGERS USING PILOTLESS VERTICAL TAKEOFF AND LANDING (VTOL) AIRCRAFT,” by inventor Tao Ma, which was filed on 6 Sep. 2016 (Atty. Docket No. MT001.US02), all of the above-listed applications are incorporated herein by reference as a part of this patent document.

### TECHNICAL FIELD

This patent document generally relates to personal transportation systems. More specifically, this patent document relates to systems, devices, and processes for transporting passengers on-demand using a fleet of pilotless vertical takeoff and landing (VTOL) aircraft traveling in three-dimensional spaces.

### BACKGROUND

This patent document provides systems and techniques for solving traffic congestion problems in urban and metropolitan areas. Conventional modes of ground transportation such as roads, rails, and ferries provide limited resources for people to commute in densely populated areas. The ever-increasing population in big cities imposes heavy burdens to these ground transport systems. An important reason that causes traffic congestion is that the ground transport vehicles travel in two-dimensional spaces. This greatly limits the amount of vehicles that can be accommodated in a particular area. An ideal route from one place to another is a straight line. Unfortunately, passengers usually have to take a longer route because there is not always a straight road between two places. This two-dimensional nature of ground transportation increases travel time, decreases energy efficiency, and can cause the aforementioned traffic congestion in high population areas. In contrast, aircraft traveling in three-dimensional spaces can be more energy efficient and are not limited by the two-dimensional routes. Moreover, aircraft traveling in three-dimensional spaces can have much higher transportation capacity because three-dimensional spaces can accommodate a much greater number of vehicles.

### SUMMARY

Techniques, systems, and devices are disclosed for safely transporting passengers from pickup locations to destination locations on demand using automated/pilotless vertical takeoff and landing (VTOL) aircraft traveling in three-dimensional (3D) spaces. In one implementation, an on-demand passenger transport system is disclosed. This on-demand passenger transport system can include one or more VTOL aircraft which operate without human pilots, and each of the one or more VTOL aircraft operates under the control of an associated onboard computer. The disclosed passenger transport system further includes a ground control system located within an urban area and communicatively coupled to the one or more VTOL aircraft. The ground control system is configured to: receive a service request from a passenger for a transport service of the one or more VTOL aircraft; assign one of the one or more VTOL aircraft to the requesting passenger; process the service request to generate a flight task; transmit the flight task to the assigned VTOL aircraft, wherein the flight task is programmed onto the onboard computer of the assigned VTOL aircraft. The onboard computer of the assigned VTOL aircraft is configured to control a flight of the assigned VTOL aircraft to safely transport the passenger from a pickup location to a destination location by air based on the received flight task.

In some embodiments, a disclosed pilotless VTOL aircraft, which provides services on demand, is able to carry one or more passengers and does not need runways to take off and land. For example, the pilotless VTOL aircraft can take off and land from designated landing pads which are located in both urban business locations and suburban residential locations.

In one aspect, a process for ensuring safe takeoff of a pilotless VTOL aircraft dispatched by a ground control system to a scheduled pickup location to serve a passenger request is disclosed. The process starts by authenticating a passenger attempting to enter the VTOL aircraft at the scheduled pickup location. If the passenger authentication is successful, the process allows the passenger to enter the VTOL aircraft. The process next performs pre-takeoff safety checks on the VTOL aircraft and the passenger inside the VTOL aircraft. If the pre-takeoff safety checks are successful, the process subsequently obtains a takeoff confirmation.

In some embodiments, the process authenticates the passenger attempting to enter the VTOL aircraft by receiving authentication information from the passenger. This authentication information can include one or more of: entering reservation codes or a password; tapping an radio frequency identification (RFID) or a near field communication (NFC) card/key-fob; scanning a barcode displayed on a mobile device of the passenger; and providing a biometric-based authentication of the passenger. In some embodiments, the biometric-based authentication includes one or more of fingerprints, facial recognition, and an eye scan.

In some embodiments, the process authenticates the passenger attempting to enter the VTOL aircraft by receiving the authentication information from the passenger and comparing the authentication information with pre-stored information of the passenger.

In some embodiments, the passenger authentication is performed either at the VTOL aircraft or at the ground control system which is configured to communicate and monitor the operation of the VTOL aircraft.

In some embodiments, the process allows the passenger to enter the VTOL aircraft by unlocking the cabin door of the VTOL aircraft.

In some embodiments, the process performs the pre-takeoff safety checks on the VTOL aircraft and the passenger by checking whether the cabin door of the VTOL aircraft is securely locked.

In some embodiments, the process performs the pre-takeoff safety checks on the VTOL aircraft and the passenger by checking whether the passenger's seatbelt is securely fastened.

In some embodiments, if the pre-takeoff safety checks are not successful, the process includes issuing reminders and/or instructions to the passenger in form of voice, signal light, or displayed text messages.

In some embodiments, the process obtains the takeoff confirmation from the passenger inside the VTOL aircraft by: prompting the passenger to confirm whether the VTOL aircraft can take off; and receiving a response from the passenger to confirm a takeoff readiness by way of a voice command, pressing a button, or touching a touchscreen in the cabin.

In some embodiments, the process obtains the takeoff confirmation from the ground control system.

In some embodiments, after obtaining the takeoff confirmation, the process allows the VTOL aircraft to initiate a takeoff procedure.

In another aspect, a process for ensuring safe landing at a destination location and completing an assigned passenger service of a pilotless VTOL aircraft is disclosed. This VTOL aircraft is communicatively coupled to and monitored by a ground control system. More specifically, the process includes notifying passengers inside the VTOL aircraft that the VTOL aircraft is about to land at the destination location. After landing the VTOL aircraft, the process notifies the passengers that the landing is completed and issues instructions on how to safely exiting the VTOL aircraft. The process then performs post-landing safety checks on the VTOL aircraft. If the post-landing safety checks are successful, the process allows the VTOL aircraft to return to a hangar or depart for another pickup location to execute a next assigned passenger service.

In some embodiments, the post-landing safety checks includes checking one or more of the following conditions: whether the passengers have left the cabin of the VTOL aircraft; whether the cabin doors of the VTOL aircraft are closed; and any other conditions that can affect the safety of the next flight of the VTOL aircraft.

In some embodiments, if any of the post-landing safety checks fails, the process further includes keeping the VTOL aircraft grounded and repeating the post-landing safety checks until the failed post-landing safety check becomes successful.

In yet another aspect, a process for detecting obstacles to ensure safe landing of a pilotless VTOL aircraft using an obstacle detection system installed on the VTOL aircraft is disclosed. This VTOL aircraft is communicatively coupled to and monitored by a ground control system. The process includes controlling the VTOL aircraft to approach a designated landing pad; detecting, using the obstacle detection system, if there is any obstacle along a landing path of the VTOL aircraft to prevent a safe landing the VTOL aircraft; if an obstacle is detected in the landing path, guiding the aircraft to maneuver away from the obstacle; and if the obstacle detection system determines that the obstacle cannot be avoid, aborting the landing procedure.

In some embodiments, the obstacle detection system detects an obstacle along the landing path by using obstacle detection sensors having three-dimensional (3D) sensing capability installed on the VTOL aircraft. For example, the obstacle detection sensors can include one or more of radars, LIDARs, and stereo cameras.

In some embodiments, the field of view of the obstacle detection sensors is configured to be at least greater than a projected area of the VTOL aircraft on the ground.

In some embodiments, the obstacle detection sensors are installed on the bottom of the VTOL aircraft for detecting if there is any obstacle below the VTOL aircraft.

In some embodiments, if the obstacle detection system determines that the VTOL aircraft cannot land onto the designated landing pad because of the detected obstacles, the process includes notifying the ground control system of the failed landing attempt. In some embodiments, after receiving the notification of the failed landing attempt from the VTOL aircraft, the ground control system assigns an alternative landing pad which is close to the designated landing pad.

In some embodiments, the landing pad includes a set of landing assistant equipments, such as visual markers, to guide the VTOL aircraft to land onto the designated landing pad with high accuracy.

In some embodiments, the process includes performing a landing pad localization maneuver by using GPS and/or inertial sensors to localize the VTOL aircraft onto the designated land pad.

In still another aspect, a process for detecting obstacles to ensure safe takeoff of a pilotless VTOL aircraft using an obstacle detection system installed on the VTOL aircraft is disclosed. This VTOL aircraft is communicatively coupled to and monitored by a ground control system. This process includes: during a takeoff procedure, detecting, using the obstacle detection system, if there is any obstacle along a takeoff path of the VTOL aircraft to prevent a safe takeoff the VTOL aircraft; if an obstacle is detected in the takeoff path, guiding the VTOL aircraft to maneuver away from the obstacle; and if the obstacle detection system determines that the obstacle cannot be avoid, returning to the ground and sending notification to the ground control system.

In some embodiments, the process detects an obstacle along the takeoff path by using obstacle detection sensors having 3D sensing capability installed on top of the VTOL aircraft to detect if there is any obstacle above the VTOL aircraft.

### BRIEF DESCRIPTION OF THE DRAWINGS

The structure and operation of the present disclosure will be understood from a review of the following detailed description and the accompanying drawings in which like reference numerals refer to like parts and in which:

FIG. 1 shows a conceptual schematic of an exemplary passenger transport system in accordance with one embodiment described herein.

FIG. 2 presents a block diagram illustrating an exemplary configuration of ground facilities of the disclosed passenger transport system in accordance with one embodiment described herein.

FIG. 3 illustrates various modules of an exemplary software control system of the disclosed passenger transport system in accordance with one embodiment described herein.

FIG. 4 presents a flow diagram illustrating an exemplary operation of the disclosed passenger transport system in accordance with one embodiment described herein.

FIG. 5 presents a flowchart illustrating an exemplary process of performing a pre-takeoff passenger safety procedure in accordance with one embodiment described herein.

FIG. 6 presents a flowchart illustrating an exemplary process of performing a landing passenger safety procedure in accordance with one embodiment described herein.

FIG. 7 presents a flowchart illustrating a VTOL aircraft landing process based on a three-step landing pad localization procedure in accordance with one embodiment described herein.

FIG. 8 illustrates an exemplary flight safety system implemented in the disclosed passenger transport system in accordance with one embodiment described herein.

### DETAILED DESCRIPTION

The rapid development of driverless car brings the hope to release human driving burden and boost driving safety. However, a driverless car needs to deal with very complex situations on the roadways, such as traffic lights, different signs, pedestrians, other vehicles, road constructions, accidents and emergencies, among others. Many random situations can arise during driving. Thus, sophisticated sensors and software systems are needed for accurately detecting and predicting such situations. This leads to the fact that driverless cars are still in its early stage of commercialization in spite of decades of research and development efforts. In contrast, situations in the air can be much simpler than the roadways because there are generally no fixed routes and obstacles in the air.

In this patent document, a vertical takeoff and landing (VTOL) aircraft is proposed as a type of vehicle to transport passengers in the air, i.e., a three-dimensional (3D) space between two locations. A VTOL aircraft does not need runways to take off and land, and typically navigates at a lower altitude and speed compared with other commercial or military aircraft, which can be ideal for personal short-range transportation in urban areas.

Recently, unmanned aerial vehicles (UAV), or drones, in the form of multicopters, experience fast development due to their mechanical simplicity and versatility. Such multicopters provide an ideal prototype for the proposed VTOL aircraft to carry passengers. For example, E-volo disclosed a manned electric-powered 18-rotor multicopter VC200 which can carry two people with more than one hour flight time [http://www.e-volo.com/ongoing-developement/vc-200]. However, hiring a pilot is expensive. A pilot onboard also reduces the load capacity, which increases the cost and reduces the efficiency. This patent document proposes using self-piloting or “pilotless” VTOL aircraft that do not rely on human pilots. The proposed VTOL aircraft is able to carry one or more passengers and navigate in urban areas on demand. In some embodiments, the proposed pilotless VTOL aircraft will be operating fully automated under the control of an onboard computer and with the assistant from a ground control center. The proposed pilotless VTOL aircraft are also referred to as “automated” VTOL aircraft below.

For the safety consideration, airborne collision avoidance system (ACAS) for civil aviation and air force has become very mature and therefore can be applied to the proposed VTOL aircraft. Moreover, the probability that a man-made aircraft hits an airborne animal (e.g., a bird or a bat) is very low. Furthermore, bird strikes should have less effect on the proposed VTOL aircraft due to the low navigation speed compared with other high speed commercial or military aircraft.

Hence, various examples of a passenger transport system based on using a fleet of pilotless VTOL aircraft to transport passengers from departure locations to arrival locations are disclosed. In some implementations, upon receiving a passenger's service request, an available pilotless VTOL aircraft is dispatched to pick up the requesting passenger at a departure location on a scheduled time and drop off the passenger at a corresponding arrival location. The flight of the VTOL aircraft can be fully automated, i.e., no human pilot is needed at any time during the execution of the flight task.

In some implementations, passengers reserve VTOL aircraft services on reservation websites using computers or portable devices. Next, a control center of the disclosed passenger transport system processes each request and assigns and dispatches multiple VTOL aircraft to carry out the services. Once flight instructions are programmed into an assigned VTOL aircraft's onboard computer, the VTOL aircraft takes off and travels to the pickup location. The onboard computer of the dispatched VTOL aircraft controls the flight at all time. Multiple sensors on the VTOL aircraft provide real time flight status for the onboard computer. The control center monitors the flight status of the airborne aircraft and feeds new instructions into the traveling aircraft if necessary. A collision avoidance system, such as an ACAS is used to ensure that the aircraft travel in “safe zones.” The disclosed passenger transport system provides a novel way of fast, short to medium range commute as well as a solution to urban traffic congestion. This passenger transport system also has broad applications in sightseeing tours, emergency rescue missions, air ambulance services, and so on.

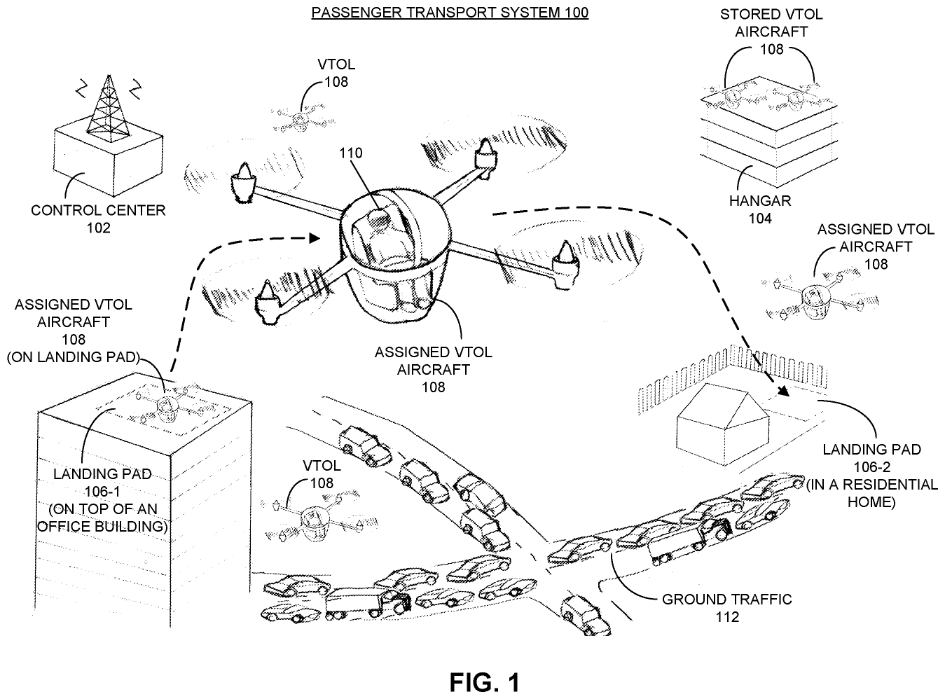

FIG. 1 shows a conceptual schematic of an exemplary passenger transport system 100 in accordance with one embodiment described herein. As can be seen in FIG. 1, the disclosed passenger transport system 100 includes a control center 102, one or more hangars 104, multiple landing pads 106, and a fleet of automated VTOL aircraft 108. In various embodiments, control center 102, hangars 104 and landing pads 106 are fixed-location structures constructed at various physical locations. For example, control center 102 can be located inside a building. However, control center 102 can also be a mobile structure, for example, when control center 102 is located inside a vehicle. In some embodiments, control center 102, hangars 104 and landing pads 106 are collectively referred to as the “ground facilities” of passenger transport system 100. For example, the ground facilities of a proposed passenger transport system in an urban area can include one control center, several hangars, and numerous landing pads.

FIG. 1 also shows an automated VTOL aircraft 108 picks up a passenger 110 at a departure location in form of a first landing pad 106-1 on top of an office building (e.g., the workplace of passenger 110) located in an urban area where traffic is heavy during the service time (as illustrated by ground traffic 112), and then travels by air above the ground traffic 112 to an arrival location in form of a second landing pad 106-2 located at a residential home. In the embodiment shown, the second landing pad 106-2 is located in the backyard of the residential home. However, the second landing pad 106-2 may be located in the front yard of the residential home or it can also be a shared landing pad near the residential home shared by multiple residential homes.

In an alternative scenario, a VTOL aircraft 108 can pick up passenger 110 from the residential home, i.e., the departure location, at the second landing pad 106-2, and then travels by air to an arrival location at the first landing pad 106-1 on top of the office building. As can be seen in FIG. 1, the proposed passenger transport system 100 completely avoids the heavy ground traffic and provides passenger 110 with a direct line-of-sight commute route.

### Automated VTOL Aircraft

In some embodiments, unlike some existing VTOL aircraft which are operated by human pilots, the disclosed automated VTOL aircraft 108 using by passenger transport system 100 do not have human pilot. In some embodiments, each of the disclosed VTOL aircraft 108 operates under the controls of both control center 102 and an onboard computer of VTOL aircraft 108. In some implementations, the disclosed VTOL aircraft 108 can have geometrical shapes or mechanical architectures of multicopter drones. However, the disclosed VTOL aircraft 108 can have other possible geometrical shapes and architectures. VTOL aircraft 108 can be electrically-powered and can have multiple electric motors and propellers. For example, the number of propellers can be 2, 3, 4, or more. Redundant power components can be included in each VTOL aircraft 108 to increase safety and reliability. In such designs, if one motor stops working, other motors can still provide sufficient lift force to keep the aircraft flying or to land the aircraft at a safe place.

In some implementations, VTOL aircraft 108 are not owned by individuals. Rather, passengers who need the transportation services can “rent” VTOL aircraft 108 for a specific amount of time, e.g., by one or more hours, in a way similar to other conventional vehicle rental services. The service requests can be placed on an online reservation website using a computer or a portable device. The service requests from the passengers are then received by control center 102, which assigns VTOL aircraft 108 and creates flight plans based on the service requests.

In some implementations, each assigned VTOL aircraft 108 receives a flight plan/task in the form of a sequence of instructions from control center 102 through radio communication channels. The flight plan can include times, locations, routes, speeds, and other information necessary to perform a flight service. The onboard computer of each VTOL aircraft 108 controls the aircraft to perform the flight plan based on these instructions. Multiple types of sensors, such as GPS, gyroscopes, light detection and ranging (LIDARs), piton tubes, cameras, can be equipped on VTOL aircraft 108. The onboard computer can process these sensor data to facilitate the control of taking off, landing, and cruising of VTOL aircraft 108. Moreover, the sensor data collected during the flight can be transmitted to control center 102, which is configured to monitor the status of VTOL aircraft 108 during the flight based on the received sensor data.

In some implementations, when a disclosed VTOL aircraft 108 needs to be recharged, the VTOL aircraft flies back to a hangar 104 for battery charging. The recharging request can be generated by the on-board computer of the VTOL aircraft 108 upon detecting a low battery condition. The recharging request can also be generated by control center 102 upon receiving sensor data from the VTOL aircraft indicating a low battery condition. After the VTOL aircraft is fully charged at the hangar, the aircraft sets off from the hangar to carry out new flight tasks.

### Ground Facilities: Control Center

In various embodiments, control center 102 of the disclosed passenger transport system 100 includes one or more computers, or a cluster of computers, and various control programs stored on the one or more computers. In some embodiments, control center 102 is a computer system that is configured to: receive service requests from passengers for transport services of VTOL aircraft 108, process passenger service requests, generate flight plans/tasks, locate and dispatch VTOL aircraft 108 (e.g., from hangar 104) to serve the passenger requests within a control range of control center 102, program the flight tasks into the dispatched VTOL aircraft 108, control the VTOL aircraft flight missions including monitoring flight status, and program new instructions into the dispatched VTOL aircraft 108 during the flight if necessary. Although only one control center 102 is shown in the system 100 of FIG. 1, other embodiments of passenger transport system 100 can include more than one control center located at multiple locations within an urban area.

Control center 102 can be operated either fully automatically or under human control. In some implementations, just one control center is set up at a single location in a given urban area. In some embodiments, after processing a received passenger request, control center 102 generates both dispatch commands and flight tasks. Control center 102 subsequently sends dispatch commands to one of the hangars 104 that store VTOL aircraft 108 or to other locations where VTOL aircraft 108 are known to be located to assign and dispatch an available VTOL aircraft 108. Control center 102 additionally transmits the generated flight tasks to the assigned aircraft for serving users' service requests.

After receiving the dispatch commands and the flight task from control center 102, an assigned VTOL aircraft 108 departs from a hangar 104 and flies to the passenger's pick up location based on the flight task. Control center 102 is configured to monitor real time conditions of the assigned aircraft 108 and change an existing flight task programmed on the assigned aircraft 108 if necessary. In some embodiments, control center 102 is capable of initiating, changing, and aborting any of the services if emergency situations arise, including weather threat, aircraft malfunction, passenger emergency, etc. Control center 102 can also send notifications regarding schedule changes to the passengers who are waiting for the VTOL services.

Control center 102 can process the sensor data received from the assigned aircraft 108 in flight to identify any safety issue which can affect the flight. Some safety issues can include weather threat along the flight route, aircraft malfunction, and passenger emergency, among others. If a safety issue is identified from the received sensor data, control center 102 can generate a modified flight task, which can include changing the flight route. The modified flight task can be then transmitted from control center 102 to the assigned aircraft 108 in-flight to reprogram the onboard computer of the aircraft. The onboard computer can be configured to subsequently control the remaining flight of the aircraft based on the modified flight task, for example, to change the course according to the new flight route, or to interrupt the flight by landing the aircraft at a safe location.

### Ground Facilities: Landing Pads

In some embodiments, each of landing pads 106 of the disclosed passenger transport system 100 includes a solid patch of surface and necessary equipments for VTOL aircraft 108 to take off and land. Landing pads 106 can be widely distributed in an urban area. For example, landing pads 106 can be set up in locations including, but are not limited to: backyards of residential homes, roofs of buildings, car parking lots, and any other places that meet taking off and landing conditions. Landing pads 106 can be either permanent or temporary. Equipments associated with a landing pad 106 can include, but are not limited to: (1) special markings for position indication; (2) signal lights for giving off safety warnings to passengers and pedestrians; (3) signal emitters and receivers for assisting VTOL aircraft 108 to take off and land; (4) fastening devices for secure VTOL aircraft 108 on the ground, and (5) radio communication devices for communicating with a VTOL aircraft 108 in a landing procedure and with control center 102. In some embodiments, a landing pad 106 can be located remotely by a landing VTOL aircraft 108 during daytime or nighttime, for example, using the signals from the aforementioned signal lights, signals emitters, and radio communication devices.

### Ground Facilities: Hangars

In some implementations, each of hangars 104 of the disclosed passenger transport system 100 can be used to store, launch, retrieve, maintain, and recharge batteries of VTOL aircraft 108. Each hangar 104 can be operated either fully automatically or under human operation. There can be just one hangar 104 or multiple hangars 104 in an urban area. VTOL aircraft 108, when not in service, can be stored at a hangar 104, as illustrated in FIG. 1.

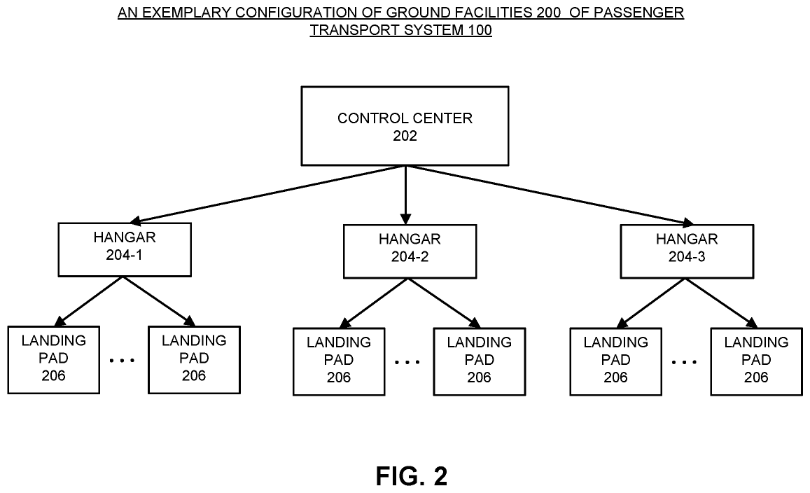

As mentioned above, control center 102, hangars 104 and landing pads 106 can be collectively referred to as the ground facilities of passenger transport system 100. For example, FIG. 2 presents a block diagram illustrating an exemplary configuration of ground facilities 200 of the disclosed passenger transport system in accordance with one embodiment described herein. As can be seen in FIG. 2, ground facilities 200 of the exemplary passenger transport system includes one control center 202, three hangars 204-1, 204-2, and 204-3 located within the control range of control center 202, and numerous landing pads 206.

### Software Control System

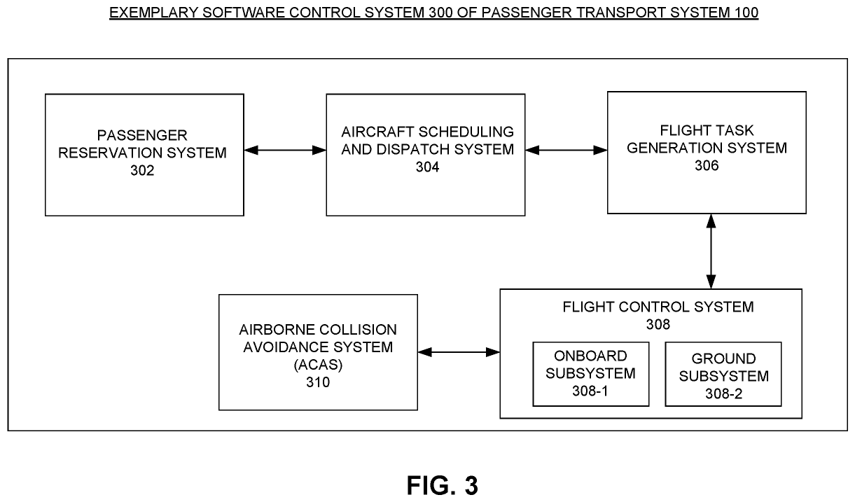

FIG. 3 illustrates various modules of an exemplary software control system 300 of the disclosed passenger transport system 100 in accordance with one embodiment described herein. As can be seen in FIG. 3, software control system 300 can include the following subsystems: a passenger reservation system 302, an aircraft scheduling and dispatching system 304, a flight task generation system 306, a flight control system 308, and an airborne collision avoidance system (ACAS) 310. However, other embodiments of passenger transport system 100 can include greater or fewer modules than the embodiment of FIG. 3.

In some embodiments, passenger reservation system 302 is configured to receive VTOL service requests from passengers, send the requests to aircraft scheduling and dispatch system 304, receive a response which includes VTOL aircraft scheduling information from aircraft scheduling and dispatch system 304, and then send response back to the requesting passengers. Passenger reservation system 302 can be implemented in a client/service architecture including both a client-side application and a server-side module. For example, the client-side application of passenger reservation system 302 can be installed and run on PCs, smartphones, laptops, tablets, or other personal computing devices of passengers. The service-side module of passenger reservation system 302 can be located and run on a computer at the disclose control center 102.

In some embodiments, aircraft scheduling and dispatch system 304 is configured to locate and assign a VTOL aircraft for a service request and subsequently assigns a new flight task to the assigned VTOL aircraft. In some embodiments, scheduling and dispatch system 304 is configured to locate and assign a VTOL aircraft based on optimizing time and cost factors. For example, scheduling and dispatch system 304 can locate a VTOL aircraft by taking into account such factors as aircraft's current positions to a pick up location, aircraft's current flight tasks, aircraft's battery conditions, weather conditions, passengers' special requests, among others. In some implementations, when a VTOL aircraft is selected to execute the scheduled service, flight task generation system 306 takes over the control of aircraft scheduling and dispatch system 304 to generate a concrete flight task (or a “flight plan,” which is used interchangeably with the term “flight task”). In various embodiments, aircraft scheduling and dispatch system 304 is located on a computer at the disclose control center 102.

In some embodiments, flight task generation system 306 is configured to generate a concrete flight plan based on the passenger service request and the conditions of the VTOL aircraft assigned to carry out the passenger service request. Flight task generation system 306 can generate the flight plan after receiving information from aircraft scheduling and dispatch system 304 indicating that an aircraft has been assigned to the passenger service request. The content of a flight plan can include time schedule, route to pick up location, route to drop-off location, flight height, flight speed, among others. A flight plan can also include a set of procedures in response to other factors, such as weather conditions, battery conditions, and passengers' special request, among others. In various embodiments, flight task generation system 306 is located on a computer at the disclose control center 102.

In some embodiments, flight control system 308 is configured to carry out a flight plan programmed onto an assigned VTOL aircraft 108 after control center 102 transmits the flight plan generated by flight task generation system 306 to the VTOL aircraft 108. In some embodiments, flight control system 308 includes at least an onboard flight control subsystem 308-1 stored in memories or other storage devices on the onboard computers of VTOL aircraft 108 as an onboard flight control system. In these embodiments, onboard flight control subsystem 308-1 automatically controls the flights of the VTOL aircraft 108, such as during taking off, landing, cruising, based on the received flight plan. To control the flight of a given VTOL aircraft 108, onboard flight control subsystem 308-1 receives the flight plan sent by control center 102, and converts the flight plan into a sequence of flight instructions corresponding to the taking off, landing, cruising and other flight procedures. When the VTOL aircraft 108 performs each flight procedure based on the flight instructions, the sensors installed on the VTOL aircraft capture flight status in real-time. Onboard flight control subsystem 308-1 can read sensor data and adjust the flight conditions of the aircraft to achieve desired flight status. In some embodiments, onboard flight control subsystem 308-1 is also responsible for sending flight status to control center 102 through radio communication channels for flight monitoring purposes.

In some embodiments, flight control system 308 also includes a ground flight control subsystem 308-2 located on a computer at control center 102 to monitor real time conditions of the assigned aircraft 108 and change an existing flight task programmed on the assigned aircraft 108 if necessary. As mentioned above, this ground flight control subsystem can process the sensor data received from an assigned aircraft 108 in flight to identify any safety issue which can affect the flight. If a safety issue is identified, ground flight control subsystem 308-2 can generate a modified flight task, which can include changing the flight route. Ground flight control subsystem 308-2 can then transmit the modified flight task from control center 102 to the assigned aircraft 108 to reprogram the onboard computer of the aircraft 108. Hence, onboard flight control subsystem 308-1 can then control the flight of the aircraft 108 based on the modified flight task, for example, to change the course according to the new flight route, or to interrupt the flight by landing the aircraft at a safe location.

In some embodiments, ACAS 310 operates to prevent VTOL aircraft 108 from colliding with other aircraft by assigning a VTOL aircraft under a threat of collision to a different height and/or routes. In some embodiments, ACAS system 310 takes effect after flight task generation system 306 assigns a new flight plan to a VTOL aircraft 108. In one embodiment, ACAS 310 runs during the entire flight of an assigned VTOL aircraft 108 from takeoff to landing to ensure no collision risk can happen at anytime during the entire execution of the flight task.

### Exemplary Operations of the Passenger Transport System

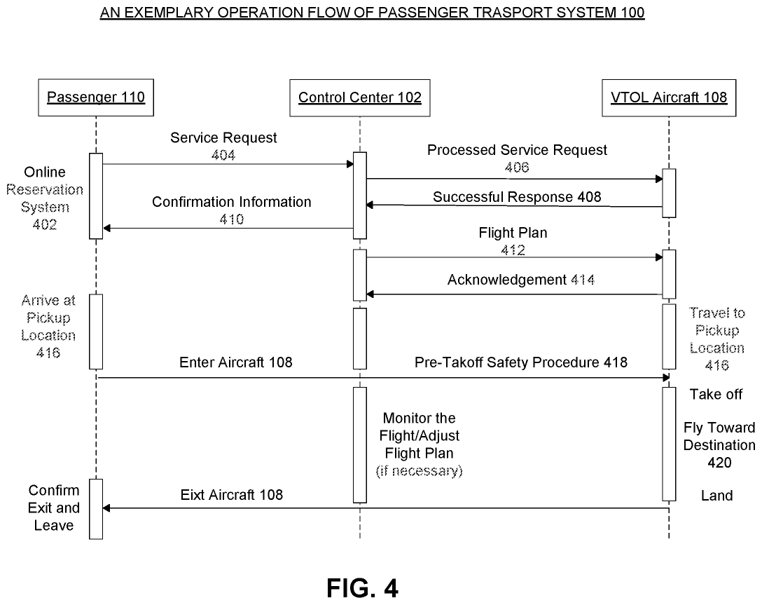

FIG. 4 presents a flow diagram illustrating an exemplary operation 400 of the disclosed passenger transport system 100 in accordance with one embodiment described herein. FIG. 4 can be understood in conjunction with passenger transport system 100 of FIG. 1.

As shown in FIG. 4, passenger 110 uses an online reservation system 402, such as a reservation website, to schedule a VTOL aircraft service by generating a service request 404. In some embodiments, service request 404 can include: (1) a pickup location; (2) a pickup time; (3) a drop-off location; and (4) other information related to the VTOL transportation service. Next, control center 102 receives and processes service request 404 and assigns an available VTOL aircraft 108 to provide the requested service. The assignment of the aircraft can be optimized based on the aircraft's current distribution, battery condition, weather, and other considerations. For example, if an aircraft is found to be near the scheduled pickup location with good service condition, this aircraft can be assigned to provide the requested service.

After sending the processed service request 406 to the assigned VTOL aircraft 108, control center 102 waits for the response from the assigned aircraft. If control center 102 receives a successful response 408 from the assigned VTOL aircraft 108 indicating that the processed service request 406 is accepted, control center 102 subsequently generates confirmation information 410 which can include: (1) a reservation confirmation; (2) a rescheduled pick up time (if necessary); (3) cost information; and (4) other instructions related to the service. Confirmation information 410 is then sent to passenger 110 and/or displayed on the user interface of online reservation system 402.

Next, control center 102 transmits a generated flight plan 412 based on the service request 404 to the assigned VTOL aircraft 108. Control center 102 then waits for an acknowledgement 414 from the assigned VTOL aircraft 108 indicating that the flight plan has been successfully received. After successfully receiving the flight plan 412, the assigned VTOL aircraft 108 travels to the pickup location 416, for example, by landing on a landing pad at pickup location 416, at the scheduled pickup time and waits for passenger 110 (if passenger 110 has not arrived).

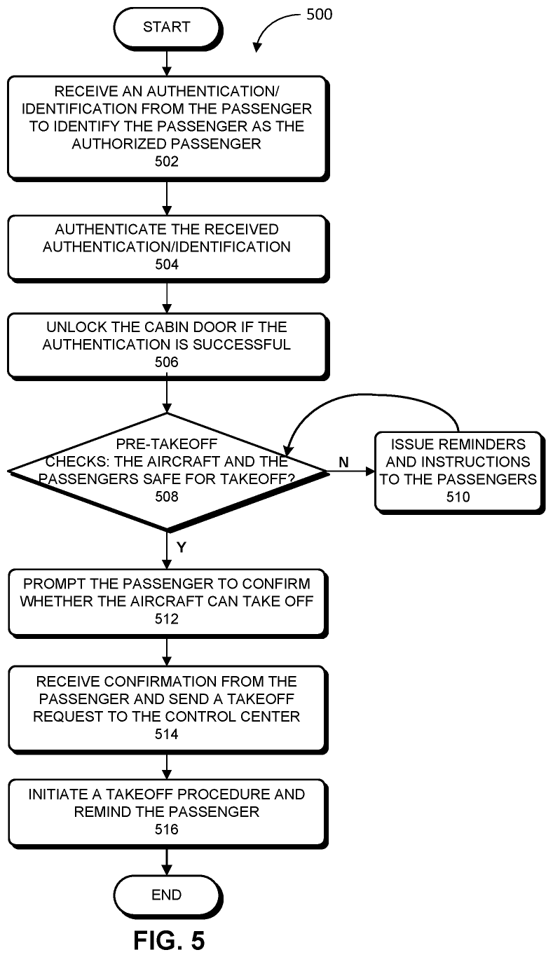

Continuing referring to FIG. 4, after receiving confirmation information 410, passenger 110 arrives at the pickup location 416 and subsequently enters the assigned VTOL aircraft 108. In some implementations, after passenger 110 enters the assigned VTOL aircraft 108 and prior to takeoff, the aircraft is configured to perform a pre-takeoff passenger safety procedure 418. For example, the assigned VTOL aircraft 108 can be configured to detect if passenger 110 is seated with seatbelt fastened. In some embodiments, aircraft 108 performs the seating and seatbelt detections using one or more onboard/cabin sensors. For example, the one or more cabin sensors can include: (1) a pressure sensor positioned on the passenger seat configured to detect the weight of a passenger; (2) a seatbelt sensor integrated with the seatbelt and configured to determine whether the seatbelt is in the buckled state or the unbuckled state; and (3) an image sensor which is configured to visually detect passenger's position and/or gesture. In some embodiments, instead of using cabin sensors to detect if passenger 110 has securely seated, aircraft 108 includes one or more buttons in the cabin configured to allow passenger 110 to press to indicate that he/she has securely seated. In further embodiments, the assigned VTOL aircraft 108 can use a combination of cabin sensor detections and passenger self-confirmations to ensure that passenger 110 has securely seated. An exemplary process of performing pre-takeoff passenger safety procedure is described below in conjunction with FIG. 5.

After confirming that passenger 110 has securely seated, the assigned VTOL aircraft 108 takes off and travels toward destination 420. In some embodiments, during the flight toward destination 420, passenger 110 has no access to the controls of the aircraft. As described above, the flight route is included in the flight plan which is generated by control center 102 and programmed into the aircraft's onboard computer. In some embodiments, the onboard computer of aircraft 108 collects aircraft sensor data during the flight and controls the flight based on the flight plan and the sensor data at all time. In some embodiments, during the flight toward destination 420, control center 102 receives sensor data from aircraft 108 and monitors the flight at all time. Control center 102 can generate new instructions to change the flight plan, such as flight route, flight height, flight speed, etc. based on the received sensor data and other factors that can affect the flight plan.

In some embodiments, after arriving at destination 420 and prior to landing, the onboard computer of aircraft 108 is configured to detect and determine if it is safe for landing based on a set of safe landing conditions. If one or more of the safe landing conditions are not met, the onboard computer prevents the aircraft 108 from landing. The aircraft can verify the safe landing conditions using either cabin sensors, or ground sensors placed at the landing pad, or using a combination of both cabin sensors and ground sensors.

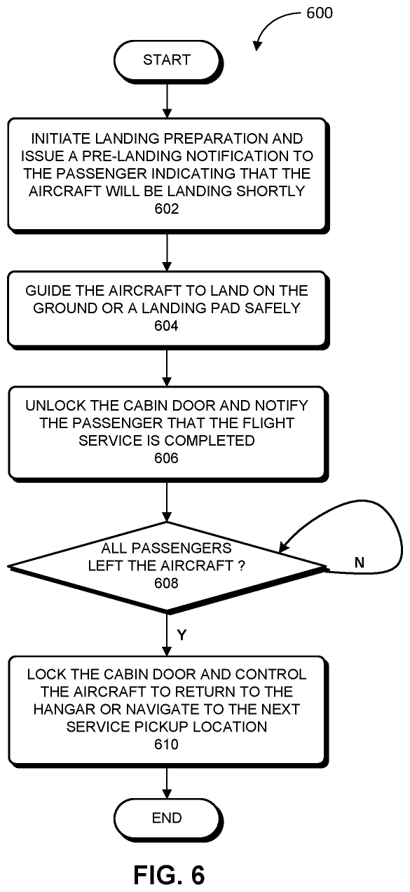

After the aircraft 108 lands at destination 420, passenger 110 exits the aircraft 108. In some embodiments, the aircraft 108 is configured to determine if passenger 110 has left the cabin using cabin sensors, or buttons for passenger to press on the cabin door indicating that passenger 110 is outside of the cabin, or a combination of these two options. An exemplary process of performing a safe landing procedure is described below in conjunction with FIG. 6. After completing the assigned flight task, control center 102 can then send new instructions to the assigned VTOL aircraft 108 for either returning to the hangar or navigating to serve a new passenger request.

### Passenger Safety Procedures During Takeoff and Landing of A VTOL Aircraft

Passenger safety can be the topmost concern of using the disclosed passenger transport system. As mentioned above, passenger safety procedures can be implemented on the assigned VTOL aircraft prior to taking-off and during/after the landing to ensure the safety of the passengers and the aircraft. An exemplary passenger safety procedure prior to the takeoff can include directing the passengers into the aircraft and ensure that the passengers are ready to fly with the aircraft. Another exemplary passenger safety procedure after landing may be implemented to direct the passengers to exit the aircraft and ensures that the aircraft can depart after finishing the current service.

FIG. 5 presents a flowchart illustrating an exemplary process 500 of performing a pre-takeoff passenger safety procedure in accordance with one embodiment described herein.

The process starts when a passenger arrives at a pickup location and attempts to enter the cabin of a VTOL aircraft, for example, by attempting to open the cabin door. The VTOL aircraft then receives a form of authentication/identification from the passenger to identify the passenger as the authorized passenger who has reserved that VTOL aircraft (step 502). In some embodiments, if multiple passengers have reserved the same service of the VTOL aircraft, each of the passengers needs to provide a corresponding authentication/identification to the VTOL aircraft. In some embodiments, the techniques for providing authentication/identification information by a person to access the VTOL aircraft can include, but are not limited to: entering a reservation confirmation number or a password, e.g., using a PIN pad outside the cabin; tapping an Radio Frequency Identification (RFID) or Near Field Communication (NFC) card/key-fob to a RFID/NFC reader outside the cabin; scanning a barcode using a handheld device, such as a smartphone; providing a biometric-based authentication, such as fingerprints, facial recognition, or eye scan; and using a physical key to open the cabin door.

Next, the received authentication/identification information is authenticated (step 504). The authentication process can be performed either at the aircraft or at the control center. In one embodiment, when the authentication takes place at the aircraft, the onboard computer of the aircraft receives the authentication/identification information and compares it to the pre-stored authentication/identification information. In another embodiment, when the authentication takes place at the control center, the control center receives the authentication/identification information and compares it to the pre-stored information. In both cases, the cabin door of the aircraft is unlocked if the authentication is successful (step 506). In some embodiments, when there are multiple passengers, the authentication is successful only if the authentication/identification information of all the passengers has been authenticated. If the authentication fails, the cabin door remains locked and an alarm may be set off.

After the passenger has entered the cabin, the cabin door is closed either by the passenger or automatically. Next, the passenger takes a seat and fastens the seatbelt. In some embodiments, the onboard computer uses multiple sensors installed inside the cabin to perform pre-takeoff checks to determine if the aircraft and the passengers are safe for takeoff (step 508). Some of the necessary checks inside the cabin can include, but are not limited to: whether the cabin door is securely closed and/or locked, and whether the passengers' seatbelts are securely fastened. If any of these pre-takeoff checks fails, reminders and instructions can be issued to the passengers in the form of voice, signal light, displayed text messages, etc (step 510). Before these pre-takeoff checks can be successfully completed, no takeoff will take place.

If the pre-takeoff checks are successfully, the onboard computer prompts the passenger to confirm whether the aircraft can take off, e.g., through voice prompts, lights, or a display (step 512). The passenger can respond the inquiry by a voice command, by pressing a button, or by touch a touchscreen in the cabin as a confirmation that the passenger is ready to take off. The above confirmation inquiry can take place after the onboard pre-takeoff checks have been completed. After receiving the readiness confirmation, the onboard computer sends a takeoff request to the control center (step 514). After receiving the permission/confirmation from the control center, the onboard computer initiates takeoff procedure and reminds the passenger that the aircraft will take off shortly (step 516). Next, the onboard system operates the aircraft to take off. In some implementations, the aircraft sends a takeoff request to the control center without requiring the passenger to provide the takeoff confirmation.

FIG. 6 presents a flowchart illustrating an exemplary process 600 of performing a landing passenger safety procedure in accordance with one embodiment described herein.

The process starts when the VTOL aircraft is approaching the landing pad of the destination location. The onboard computer initiates landing preparation and issues a pre-landing notification to the passenger indicating that the aircraft will be landing shortly (step 602). Next, the onboard computer guides the aircraft to land on the ground or a landing pad safely (step 604). As this point, the onboard computer can shut down the aircraft engines, including stopping all propeller rotation. The onboard computer then unlocks the cabin door and notifies the passenger that the flight service is completed (step 606). The onboard computer can also issue instructions on how to safely exit the aircraft. At this time, the passenger can remove the seatbelt, open the cabin door, and exit the cabin. The onboard computer next determines if all passengers have left the aircraft (step 608). If so, the onboard system locks the cabin door and controls the aircraft to return to the hangar or navigate to the next service pickup location (step 610). If not, the onboard system waits and repeats step 608 until all passengers have left the aircraft.

In some implementations, prior to taking off after finishing the current passenger transport service, the onboard computer of the VTOL aircraft is configured to inspect the aircraft cabin by performing following checks: (1) if all passengers have left the aircraft; (2) if the cabin doors are closed; and (3) any other conditions that can affect the safety of the next flight. If any of the checks fails, the onboard computer keeps the aircraft grounded and waits for the above conditions to be satisfied. For example, the onboard computer can be configured to repeat these checks after a predetermined time duration. In some embodiments, when the onboard computer verifies that the conditions of the aircraft have met the required takeoff conditions, the aircraft takes off and returns to the hangar or depart to a new destination to execute the next assigned passenger service.

### Obstacle Detection During Takeoff and Landing

In various embodiments, before and during the takeoff and during landing, a disclosed VTOL aircraft is configured to avoid any obstacle on its moving path. Obstacles can include objects on the ground (e.g., pedestrians, cars, etc.) or above the ground (e.g., wires, poles, trees, etc). In some embodiments, when an obstacle is detected in the moving path, the aircraft's onboard flight control system, such as onboard subsystem 308-1 described in FIG. 3 is configured to guide the aircraft to maneuver away from the obstacle. If the onboard flight control system determines that aircraft cannot avoid the obstacle, the takeoff or landing procedure would be aborted.

In some exemplary systems, additional sensors having 3D sensing capability for obstacle detection can be installed on the VTOL aircraft. These obstacle detection sensors can be installed on the top, on the side, or on the bottom of the VTOL aircraft. Some sensors that can be used for this function include radars, LIDARs, and stereo cameras. In some embodiments, the sensors' field of view is configured to be at least greater than the projected area of the full aircraft profile.

In one example, during a landing procedure, the obstacle detection sensors installed on the bottom of the VTOL aircraft detect if there is any obstacle below the aircraft. If the obstacle detection system determines that the aircraft cannot land onto the designated landing pad after a few attempts because of the detected obstacles, the onboard computer of the aircraft sends notification back to the control center. The control center may then assign another landing pad which is close to the current landing pad. The aircraft then navigates to the new landing pad and attempts to land at the new location. In another example, during a takeoff procedure, the obstacle detection sensors installed on the top of the aircraft detect if there is any obstacle above the aircraft. If the obstacle detection system determines that the aircraft cannot take off after a few attempts because of detected obstacles, the onboard computer of the aircraft controls the aircraft to return to the landing pad and sends notification to the control center.

### Landing Pad Localization

In some embodiments, the landing pads of the disclosed passenger transport system can include landing assistant equipments, such as visual markers. In particular embodiments, the visual makers can be made of LEDs or other light sources that can emit visible or invisible lights toward the sky. In these embodiments, the VTOL aircraft also includes light detectors to receive the lights from the visual makers to identify the location of the landing pad. In some embodiments, the landing assistant equipments on the land pads include radio wave emitters that can emit RF signals at particular frequencies. The landing pads with landing assistant equipments may be used in those places where landing accuracy is crucial, such as in residential areas, parking lots, roofs of buildings, etc. These landing assistant equipments are designed to guide the aircraft to land in the designated areas with high accuracy.

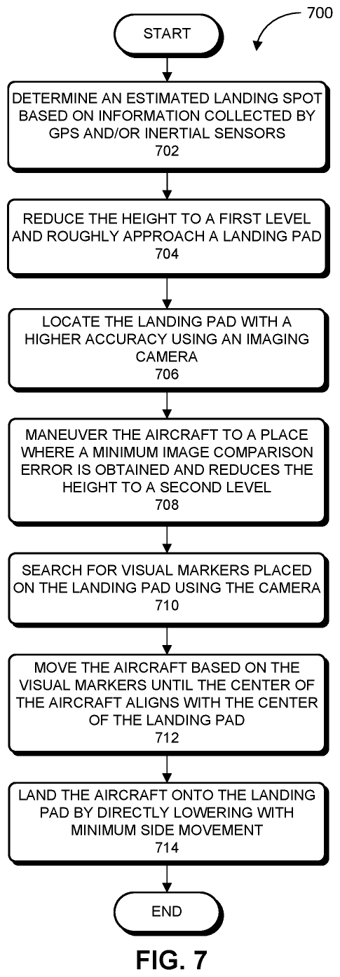

In some embodiments, the VTOL aircraft performs landing pad localization maneuver by using a GPS and/or inertial sensors to localize itself onto the land pad. In some exemplary systems, the accuracy of the GPS is around 30 feet. The accuracy of inertial sensors may depend on how long the aircraft travels. In some cases, both types of sensors cannot provide enough accuracy for landing the aircraft in a relative narrow area. In such cases, a three-step landing pad localization procedure can be used. FIG. 7 presents a flowchart illustrating a VTOL aircraft landing process 700 based on a three-step landing pad localization procedure in accordance with one embodiment described herein.

The process starts when the VTOL aircraft determines an estimated landing spot based on the information collected by GPS and/or onboard inertial sensors (step 702). Next, the aircraft reduces the height to a first level and roughly approaches the landing pad (step 704).

Next, an imaging camera sensor on the VTOL aircraft facing downward is used to locate the landing pad with a higher accuracy (step 706). In some embodiments, the captured images by the camera are continuously compared to the pre-stored images of and around the same landing pad. The aircraft gradually maneuvers itself to a place where a minimum matching error is obtained (step 708). The place with this minimum matching error indicates that the aircraft is roughly above the desired land spot. The aircraft additionally reduces the height above the land pad to a second level during this step.

Next, the imaging camera facing downward begins to search for visual markers placed on the landing pad (step 710). These visual markers indicate the geometrical shape and boundary of the landing pad. In some embodiments, a dedicated program stored on the onboard computer is used to locate these visual markers and subsequently estimates the deviation to the landing pad. The aircraft continues to move based on the visual markers until the center of the aircraft aligns with the center of the landing pad (step 712). This step can achieve the highest localization accuracy. Finally, the aircraft lands onto the landing pad by directly lowering the aircraft with minimum side movement toward the landing pad (step 714).

In some implementations, the aircraft can also land on areas without landing assistant equipments. This setup may be used in the situations where landing accuracy is not crucial, such as on open ground without any obstacles. In such cases, the localization of landing areas may primarily rely on GPS and/or inertial sensors. However, obstacle detection may still be necessary in these cases to prevent human trespassing on the ground during takeoff and landing.

### Flight Safety Subsystems

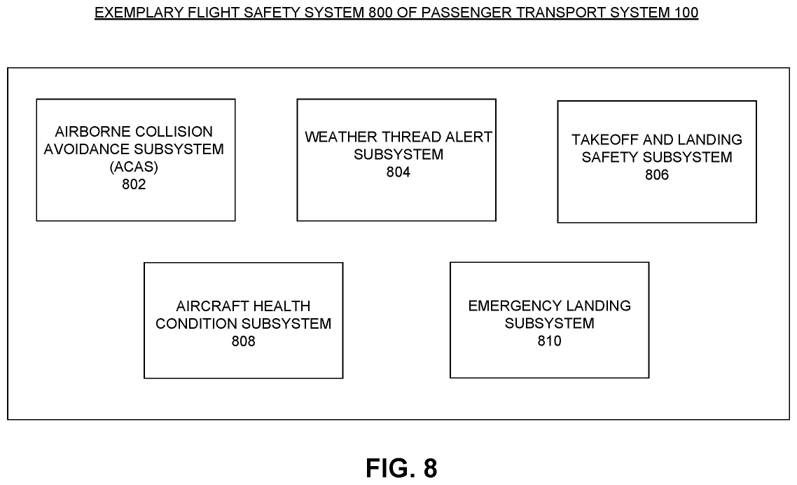

In various embodiments, to reduce the flight safety risks to the passengers and to the VTOL aircraft as much as possible, one or more of the flight safety subsystems can be implemented in the disclosed passenger transport system, wherein each of the safety subsystems can be implemented in software, hardware which can include sensors and/or detectors, or a combination of software and hardware. FIG. 8 illustrates an exemplary flight safety system 800 implemented in the disclosed passenger transport system in accordance with one embodiment described herein. Note that the software components of flight safety system 800 can be implemented on both ground flight control subsystem 308-2 and onboard flight control subsystem 308-1 described in FIG. 3.

As can be seen in FIG. 8, flight safety system 800 includes an airborne collision avoidance subsystem (ACAS) 802, which is configured to prevent the risk of aircraft collision as describe above. Flight safety system 800 also includes a weather thread alert subsystem 804. In some embodiments, weather thread alert subsystem 804 collects weather information in an urban area from third party weather report providers. Using the collected weather threat information by weather thread alert subsystem 804, during the flight task generation process, the control center can generate planned flight routes which would prevent the VTOL aircraft from flying through airspaces where hazardous weather exists. In some implementations, the weather thread alert subsystem 804 checks those VTOL aircraft in the air iteratively to ensure all the in-flight aircraft operate in safe zones. In some embodiments, if a weather threat is predicted on a VTOL aircraft's planned route, weather thread alert subsystem 804 operates to notify the flight task generation system (e.g., flight task generation system 308 in FIG. 3) at the control center to make a new flight route for the assigned VTOL aircraft.

Flight safety system 800 can additionally include a takeoff and landing safety subsystem 806. As described above, takeoff and landing safety subsystem 806 identifies, resolves, and prevents threats from ground objects, passengers, and pedestrians during the takeoff and landing of the VTOL aircraft. For example, takeoff and landing safety subsystem 806 can include various light sources and/or sound sources placed outside of the VTOL aircraft and/or around the landing pads for the planned purposes. In various embodiments, takeoff and landing safety subsystem 806 is configured to perform or assist the executions of the various processes 500-700 described in conjunction with FIGS. 5-7.

Flight safety system 800 also includes an aircraft health condition subsystem 808. In some embodiments, aircraft health condition subsystem 808 is configured to monitor various health conditions of the VTOL aircraft, such as battery conditions, and to ensure that the VTOL aircraft operate under the desired service health conditions. Flight safety system 800 can additionally include an emergency landing subsystem 810. In some embodiments, emergency landing subsystem 810 is configured to provide contingency plans for the VTOL aircraft during flight. For example, if a VTOL aircraft encounters an emergency situation, emergency landing subsystem 810 can allow the distressed aircraft to land on a safe location as soon as possible.

While this patent document contains many specifics, these should not be construed as limitations on the scope of any invention or of what may be claimed, but rather as descriptions of features that may be specific to particular embodiments of particular inventions. Certain features that are described in this patent document and attached appendix in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this patent document.

What is claimed is:

1. A computer-implemented method for performing a pre-takeoff passenger safety procedure for a pilotless vertical takeoff and landing (VTOL) aircraft, the method comprising:
receiving authentication information from each of one or more passengers attempting to enter a passenger cabin of the VTOL;
authenticating each of the one or more passengers as an authorized passenger based on the received authentication information; and
if the one or more passengers are successfully authenticated,
allowing the one or more passengers to enter the passenger cabin of the VTOL aircraft;
performing a set of onboard pre-takeoff checks to determine if the VTOL aircraft and the one or more passengers are safe for takeoff; and
in response to determining that the VTOL aircraft and the one or more passengers are safe for takeoff, further confirming readiness of each of the one or more passengers for immediate takeoff.

2. The computer-implemented method of claim 1, wherein receiving the authentication information from each of one or more passengers includes one of:
receiving a confirmation number or a password on a PIN pad outside the passenger cabin;
receiving an Radio Frequency Identification (RFID)/Near Field Communication (NFC) signal through a RFID/NFC reader outside the passenger cabin;
receiving a barcode through a handheld device;
receiving a biometric-based authentication directly from the passenger; and
a combination of the above.

3. The computer-implemented method of claim 1, wherein authenticating each of the one or more passengers as the authorized passenger includes comparing the received authentication information to pre-stored authentication information.

4. The computer-implemented method of claim 1, wherein if the one or more passengers are successfully authenticated, the method further includes unlocking a door of the passenger cabin to allow the one or more passengers to enter the passenger cabin.

5. The computer-implemented method of claim 1, wherein the one or more passengers are successfully authenticated only if each passenger of the one or more passengers has been successfully authenticated.

6. The computer-implemented method of claim 1, wherein performing the set of onboard pre-takeoff checks to determine if the VTOL aircraft and the one or more passengers are safe for takeoff includes:
determining whether the door of the passenger cabin is securely closed and locked; and
determining whether seatbelts of the one or more passengers are securely fastened.

7. The computer-implemented method of claim 1, wherein if any of the set of onboard pre-takeoff checks fails, the method further comprises generating a reminder and instructions on how to perform secure seating to the one or more passengers.

8. The computer-implemented method of claim 1, wherein confirming readiness of each of the one or more passengers for takeoff includes:
prompting the one or more passengers to provide readiness confirmation; and
receiving a confirmation from each of the one or more passengers.

9. The computer-implemented method of claim 8, wherein receiving the confirmation from each of the one or more passengers including using one of the following:
receiving the confirmation through a voice command of the passenger;
receiving the confirmation through a button pressed by the passenger; and
receiving the confirmation through a touchscreen touched by the passenger.

10. The computer-implemented method of claim 8, wherein after receiving the confirmation from each of the one or more passengers, the method further comprises:
sending a takeoff request from the VTOL aircraft to a land-based control center;
receiving a permission to take off from the control center; and
initiating a takeoff procedure so that the VTOL aircraft begins a new flight.

11. A pilotless vertical takeoff and landing (VTOL) aircraft, comprising:
a passenger cabin with a secure door;
an onboard computer, wherein the onboard computer is configured to control a pre-takeoff passenger safety procedure for the VTOL aircraft by:
receiving authentication information from each of one or more passengers attempting to enter the passenger cabin of the VTOL;
authenticating each of the one or more passengers as an authorized passenger based on the received authentication information; and
if the one or more passengers are successfully authenticated,
allowing the one or more passengers to enter the passenger cabin;
performing a set of onboard pre-takeoff checks to determine if the VTOL aircraft and the one or more passengers are safe for takeoff; and
in response to determining that the VTOL aircraft and the one or more passengers are safe for takeoff, further confirming readiness of each of the one or more passengers for immediate takeoff.

12. The VTOL aircraft of claim 11, wherein the onboard computer is configured to receive the authentication information from each of one or more passengers by:
receiving a confirmation number or a password on a PIN pad outside the passenger cabin;
receiving an Radio Frequency Identification (RFID)/Near Field Communication (NFC) signal through a RFID/NFC reader outside the passenger cabin;
receiving a barcode through a handheld device;
receiving a biometric-based authentication directly from the passenger; and
a combination of the above.

13. The VTOL aircraft of claim 11, wherein the onboard computer is configured to authenticate each of the one or more passengers as the authorized passenger by comparing the received authentication information to pre-stored authentication information.

14. The VTOL aircraft of claim 11, if the one or more passengers are successfully authenticated, the onboard computer is further configured to unlock a door of the passenger cabin to allow the one or more passengers to enter the passenger cabin.

15. The VTOL aircraft of claim 14, wherein the onboard computer is configured to perform the set of onboard pre-takeoff checks by:
determining whether the door of the passenger cabin is securely closed and locked; and
determining whether seatbelts of the one or more passengers are securely fastened.

16. The VTOL aircraft of claim 11, wherein if any of the set of onboard pre-takeoff checks fails, the onboard computer is configured to generate a reminder and instructions on how to perform secure seating to the one or more passengers.

17. The VTOL aircraft of claim 11, wherein the onboard computer is configured to confirm readiness of each of the one or more passengers for takeoff by:
prompting the one or more passengers to provide readiness confirmation; and
receiving a confirmation from each of the one or more passengers.

18. The VTOL aircraft of claim 17, wherein the onboard computer is configured to receive the confirmation from each of the one or more passengers by using one of the following:
receiving the confirmation through a voice command of the passenger;
receiving the confirmation through a button pressed by the passenger; and
receiving the confirmation through a touchscreen touched by the passenger.

19. The VTOL aircraft of claim 17, wherein after receiving the confirmation from each of the one or more passengers, the onboard computer is further configured to:
send a takeoff request from the VTOL aircraft to a land-based control center;
receive a permission to take off from the control center; and
initiate a takeoff procedure so that the VTOL aircraft begins a new flight.

20. A computer-implemented method for performing a safe landing procedure for a pilotless vertical takeoff and landing (VTOL) aircraft at the end of a flight, the method comprising:
issuing a pre-landing notification to one or more passengers onboard the VTOL aircraft indicating that the VTOL aircraft will be landing shortly; and
upon landing the VTOL aircraft on the ground or a landing pad,
notifying the one or more passengers that the flight is completed;
unlocking a cabin door of the VTOL aircraft;
determining if all of the one or more passengers have exited the VTOL aircraft; and
in response to determining that the one or more passengers have exited the VTOL aircraft,
locking the cabin door; and
controlling the VTOL aircraft to return to the hangar or navigate to the next service pickup location.
